(19) United States
(12) Patent Application Publication
(10) Pub. No.: US 2023/0196214 A1
(43) Pub. Date: Jun. 22, 2023

(54) COMPUTER IMPLEMENTED SYSTEMS, SOFTWARE, AND METHODS FOR GOLF COURSE ACTIVITIES MANAGEMENT

(71) Applicants: Edmund Cordero, Frisco, TX (US); Lawrence Zaiter, McKinney, TX (US)

(72) Inventors: Edmund Cordero, Frisco, TX (US); Lawrence Zaiter, McKinney, TX (US)

(21) Appl. No.: 18/060,888

(22) Filed: Dec. 1, 2022

Related U.S. Application Data
(60) Provisional application No. 63/251,380, filed on Oct. 1, 2021.

(51) Int. Cl. G06Q 10/02; G06Q 10/1093; H04W 68/00

(52) U.S. Cl. CPC G06Q 10/02; G06Q 10/1093; H04W 68/005

(57) ABSTRACT

A computing system to manage golf course activities includes functions configured to output a GUI to a display, determine a golf course tee time reservation event, output a the first update based on the golf course tee time reservation event, determine, based upon a first confirmation request and an associated first set time period, a first result indicating whether to modify the golf course tee time reservation event to a confirmed golf course tee time reservation event or a cancelled golf course tee time reservation event. Functions are also configured to output an updated personal golf activities schedule, determine a golf course tee time wait list event, output the golf course tee time wait list event and the personal golf activities schedule, and determine, in response to a second confirmation request and an associated second set time period, a second result indicating whether to modify the golf course tee time wait list event to a confirmed golf course tee time wait list event.

### RELATED APPLICATIONS

This application claims priority to U.S. Provisional Application Ser. No. 63/251,380 filed Oct. 1, 2021 titled “COMPUTER IMPLEMENTED SYSTEMS, SOFTWARE, AND METHODS FOR GOLF COURSE ACTIVITIES MANAGEMENT” which is incorporated herein in its entirety by reference.

### FIELD OF THE INVENTION

The present invention relates to systems, software applications, and methods for computer networks and mobile devices, and more specifically for managing golf course reservations and activities

### BACKGROUND

Golf courses, golf clubs or Country clubs may allow their Members to book tee times up to a week in advance. Most Members rush to secure desired tee time(s) online, block groups with “TBD” and guest names. On occasion, they forget to cancel the TBD, Guest and/or simply don’t show up to play. This practice prohibits other Members from playing at preferred times and reduces revenue for the Club through cart fees, green and cart fees for guests, food & beverage, and Pro-Shop merchandise sales. Members are not currently penalized when they fail to cancel in a timely manner or “no-show”.

There is a need for a system and process that can timely confirm reservations, reduce no-shows, increase or maximize available playing times, and increase golf course revenue.

### SUMMARY

The present application discloses embodiments including and/or related to systems, methods, and apparatus that deliver improvements in computer-implemented technology by providing oversight to Members and mitigating the revenue losses due to “no-shows” by pulling in Members that are ready-to-play during preferred times. The system including the use of a mobile application will synchronize with golf course booking systems. Push notifications may be sent to each Member. Notifications can be custom set for tee time reminders, ability to cancel vs. “no show”, and provide day-of golf notifications and services to improve the Members experience.

In a first aspect, a computing system to manage golf course activities is provided. The computer system includes one or more hardware processors and associated memory configured by machine-readable instructions. Execution of the executable instructions by the processor causes the computing system to perform functions. The functions can be configured to: output a graphical user interface (GUI) to a display of a computing system at which a golf course activities manager is configured to be accessed; determine a golf course tee time reservation event corresponding to a user accessing the golf course activities manager at the computing system; output, to the display a first update to the GUI, the first update based on the golf course tee time reservation event and a personal golf activities schedule corresponding to the user; determine, based upon a first confirmation request and an associated first set time period, a first result indicating whether to modify the golf course tee time reservation event to one of a confirmed golf course tee time reservation event and a cancelled golf course tee time reservation event; output, to the display based upon the first result, an updated personal golf activities schedule corresponding to the user; determine a golf course tee time wait list event corresponding to the user accessing the golf course activities manager at the computing system; output, to the display a second update to the GUI, the second update based on the golf course tee time wait list event and the personal golf activities schedule corresponding to the user; determine, in response to a second confirmation request and an associated second set time period, a second result indicating whether to modify the golf course tee time wait list event to a confirmed golf course tee time wait list event; and output, to the display based upon the second result, the updated personal golf activities schedule corresponding to the user.

Additionally and/or alternatively, the confirmed golf course tee time reservation event and the confirmed golf course tee time wait list event each comprise a date, time, and location of a tee time.

Additionally and/or alternatively, the first confirmation request comprises a first push notification received at the computing system and requesting confirmation or cancellation of the tee time within the first set time period.

Additionally and/or alternatively, the first result defaults to the cancelled golf course activity reservation event if the first set time period is exceeded without a user response to the first confirmation request.

Additionally and/or alternatively, the second confirmation request comprises a second push notification received at the computing system and requesting confirmation or cancellation of the tee time within the second set time period.

Additionally and/or alternatively, the second result does not result in the confirmed golf course wait list event if the second set time period is exceeded without a user response to the second confirmation request.

Additionally and/or alternatively, the one or more hardware processors are further configured by machine-readable instructions to output, to the display, golf course conditions updates to the GUI, the golf course conditions updates based on the personal golf activities schedule corresponding to the user and one or more of weather updates, tee times delays, course modifications, and/or course closures.

Additionally and/or alternatively, the one or more hardware processors are further configured by machine-readable instructions to establish, by the computing system within a computer readable memory, the personal golf activities schedule corresponding to the user; wherein the personal golf activities schedule includes a user identifier, golf course tee time reservation events, confirmed golf course tee time reservation events, cancelled golf course tee time reservation events, golf course tee time wait list events, and confirmed golf course tee time wait list events, associated with the user; and wherein a processor of the computing system is configured to read the computer readable memory to determine the personal golf activities schedule and write to the computer readable memory to change the personal golf activities schedule.

Additionally and/or alternatively, the one or more hardware processors are further configured by machine-readable instructions to: establish, by the computing system within the computer readable memory, a rewards account corresponding to the user; and determine, based upon at least user responses to confirmation requests, reward points to be awarded to, or removed from, the rewards account.

In a second aspect, a method to manage golf course activities is provided. The method can include: outputting a graphical user interface (GUI) to a display of a computing system at which a golf course activities manager is configured to be accessed; determining a golf course tee time reservation event corresponding to a user accessing the golf course activities manager at the computing system; outputting, to the display a first update to the GUI, the first update based on the golf course tee time reservation event and a personal golf activities schedule corresponding to the user; determining, based upon a first confirmation request and an associated first set time period, a first result indicating whether to modify the golf course tee time reservation event to one of a confirmed golf course tee time reservation event and a cancelled golf course tee time reservation event; outputting, to the display based upon the first result, an updated personal golf activities schedule corresponding to the user; determining a golf course tee time wait list event corresponding to the user accessing the golf course activities manager at the computing system; outputting, to the display a second update to the GUI, the second update based on the golf course tee time wait list event and the personal golf activities schedule corresponding to the user; determining, in response to a second confirmation request and an associated second set time period, a second result indicating whether to modify the golf course tee time wait list event to a confirmed golf course tee time wait list event; and outputting, to the display based upon the second result, the updated personal golf activities schedule corresponding to the user.

Additionally and/or alternatively, the confirmed golf course tee time reservation event and the confirmed golf course tee time wait list event each comprise a date, time, and location of a tee time.

Additionally and/or alternatively, the first confirmation request comprises a first push notification received at the computing system and requesting confirmation or cancellation of the tee time within the first set time period.

Additionally and/or alternatively, the first result defaults to the cancelled golf course activity reservation event if the first set time period is exceeded without a user response to the first confirmation request.

Additionally and/or alternatively, the second confirmation request comprises a second push notification received at the computing system and requesting confirmation or cancellation of the tee time within the second set time period.

Additionally and/or alternatively, the second result does not result in the confirmed golf course wait list event if the second set time period is exceeded without a user response to the second confirmation request.

Additionally and/or alternatively, the method may include outputting, to the display golf course conditions updates to the GUI, the golf course conditions updates based on the personal golf activities schedule corresponding to the user and one or more of weather updates, tee times delays, course modifications, and/or course closures.

Additionally and/or alternatively, the method may include establishing, a computer readable memory, the personal golf activities schedule corresponding to the user; wherein the personal golf activities schedule includes a user identifier, golf course tee time reservation events, confirmed golf course tee time reservation events, cancelled golf course tee time reservation events, golf course tee time wait list events, and confirmed golf course tee time wait list events, associated with the user; and wherein a processor of a computing system is configured to read the computer readable memory to determine the personal golf activities schedule and write to the computer readable memory to change the personal golf activities schedule.

Additionally and/or alternatively, the method may include establishing, within the computer readable memory, a rewards account corresponding to the user; and determining, based upon at least user responses to requests, reward points to be awarded to, or removed from, the rewards account.

In a third aspect, a computer-readable memory is provided. The computer-readable memory has stored therein instructions executable by a processor to cause a computing system to perform functions. The functions include: outputting a graphical user interface (GUI) to a display of a computing system at which a golf course activities manager is configured to be accessed; determining a golf course tee time reservation event corresponding to a user accessing the golf course activities manager at the computing system; outputting, to the display a first update to the GUI, the first update based on the golf course tee time reservation event and a personal golf activities schedule corresponding to the user; determining, based upon a first confirmation request and an associated first set time period, a first result indicating whether to modify the golf course activity reservation event to one of a confirmed golf course tee time reservation event and a cancelled golf course tee time reservation event; outputting, to the display based upon the first result, an updated personal golf activities schedule corresponding to the user; determining a golf course tee time wait list event corresponding to the user accessing the golf course activities manager at the computing system; outputting, to the display a second update to the GUI, the second update based on the golf course tee time wait list event and the personal golf activities schedule corresponding to the user; determining, in response to a second confirmation request and an associated second set time period, a second result indicating whether to modify the golf course tee time wait list event to a confirmed golf course tee time wait list event; and outputting, to the display based upon the second result, the updated personal golf activities schedule corresponding to the user.

Additionally and/or alternatively, the first confirmation request comprises a first push notification received at the computing system and requesting confirmation or cancellation of the tee time within the first set time period, the first result defaults to the cancelled golf course activity reservation event if the first set time period is exceeded without a user response to the first confirmation request, the second confirmation request comprises a second push notification received at the computing system and requesting confirmation or cancellation of the tee time within the second set time period, and the second result does not result in the confirmed golf course wait list event if the second set time period is exceeded without a user response to the second confirmation request.

The embodiments provide an enterprise resource software application that digitally enhances the golf course members’ experience. The system and method provide a single resource point to access dynamic and timely wait lists, calendar updates, weather notices, food & beverage purchases, and other member related experience enhancements while simultaneously offering a rewards system for participation.

### BRIEF DESCRIPTION OF THE DRAWINGS

The figures which accompany the written portion of this specification illustrate embodiments and method(s) of use according to the teachings of the present invention.

FIG. 1 shows a schematic block diagram illustrating a communication system including golf course activities management capabilities on servers and mobile devices according to an embodiment of the present invention.

FIG. 2 is a schematic block diagram illustrating the components of a computing device (e.g. a mobile device) according to an embodiment of the present invention of FIG. 1.

FIGS. 3-11 are front views illustrating a Golfer’s mobile device displaying a Graphical User Interface (GUI) with various example screens regarding scheduling, confirmations, food & beverage ordering, and summaries for the Golf Course Management System and Method according to an embodiment of the present invention of FIG. 1.

FIG. 12 is front view illustrating a Golf Course Starter’s mobile device displaying a Graphical User Interface (GUI) with an example screen for the Golf Course Management System and Method according to an embodiment of the present invention of FIG. 1.

FIGS. 13-16 are front views illustrating a Golfer’s mobile device displaying a Graphical User Interface (GUI) with various example screens regarding weather/course information for the Golf Course Management System and Method according to an embodiment of the present invention of FIG. 1.

FIG. 17 is a flowchart illustrating the system and process architecture flowchart according to an embodiment of the present invention.

FIG. 18 is a block diagram of a computing system configured for providing the Golf Course Management System and Method, in accordance with the example embodiments.

FIG. 19 is a flow chart showing functions of a method for providing the Golf Course Management System and Method, in accordance with the example embodiments.

All the figures are schematic, not necessarily to scale, and generally only show parts which are necessary to elucidate example embodiments, wherein other parts can be omitted or merely suggested.

The various embodiments of the present invention will hereinafter be described in conjunction with the appended drawings, wherein like designations denote like elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

As discussed above, embodiments of the present invention relate to golf course management and more particularly to a system, software (e.g. host platform and mobile device application), and method, used to improve the use of golf course activities and resources.

Generally speaking, depending on the type of wireless communication system, a wireless communication device or mobile device, such as a smartphone, cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel or channels. For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

The present embodiments are generally directed to a golf course management approach that increases or maximizes the use of the golf course and associated resources.

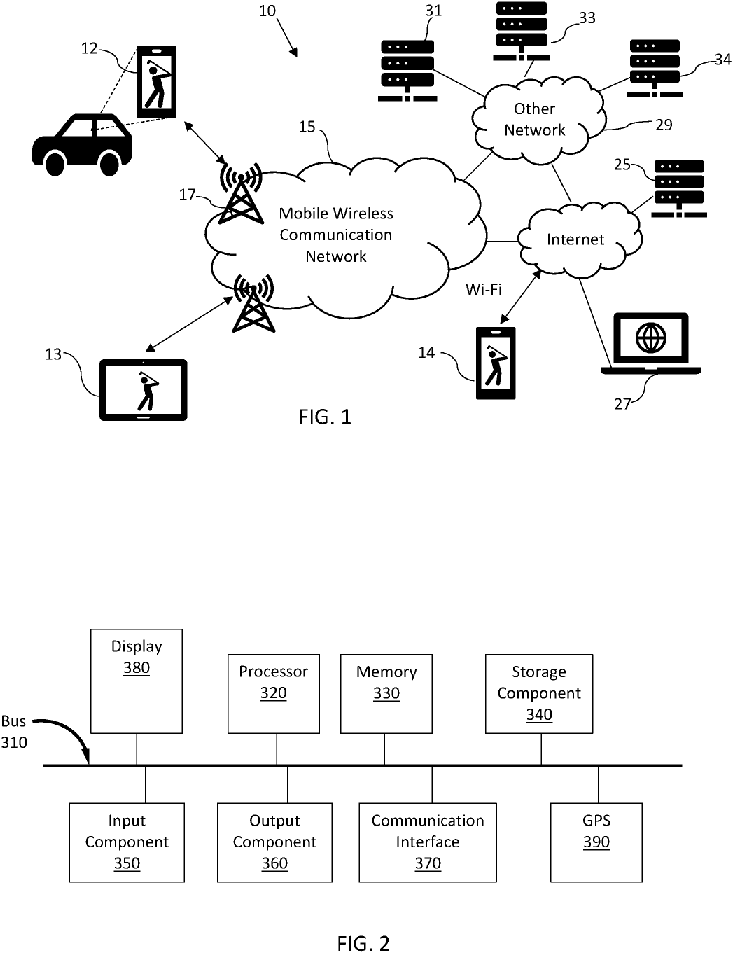

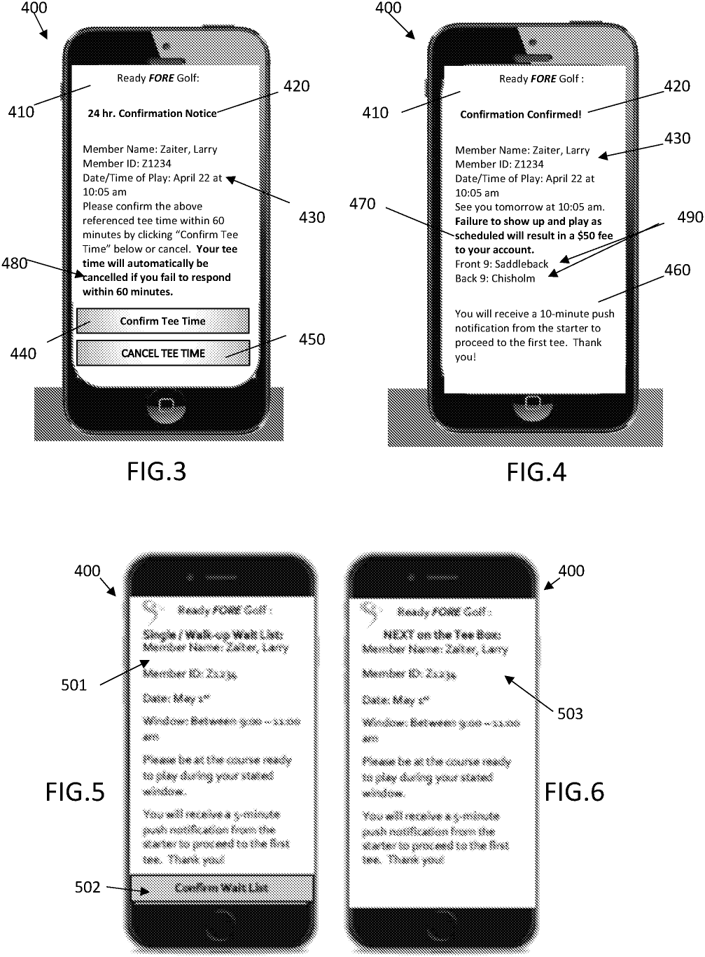

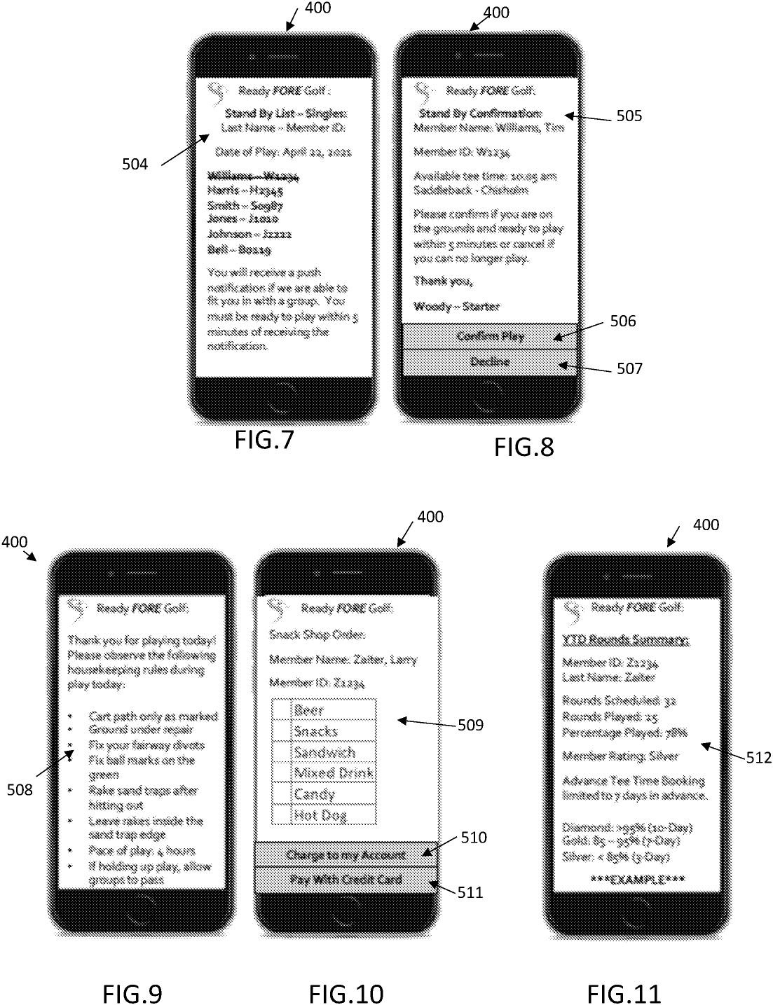

FIG. 1 illustrates a system 10 offering a variety of golfing management services, including communications in support of providing golfing management communications for users’ mobile devices. The example shows three mobile devices 12, 13, and 14 as well as a mobile wireless communication network 15. The devices 12-14 are examples of computing devices that may execute an application configured to provide the golf course management functionality. The network 15 provides mobile wireless communications services to those devices as well as to other mobile devices via several base stations 17. The present techniques may be implemented in any of a variety of available mobile networks 15 and/or on any type of mobile devices compatible with such a network 15.

Some mobile devices 12-14 may be operative to communicate using a variety of communication networks and protocols other than those used for communication through the mobile wireless network 15. For example, as shown for device 14, at least some mobile devices are additionally or alternatively configured for data communication through a wireless communication link such as a Wi-Fi link. Mobile devices communicating through Wi-Fi communication links may access Internet-connected servers and services directly through the Internet 23, and/or access servers and services provided by a carrier of the mobile wireless network 15 via the Internet 23 and a private network 29 operated by the carrier.

The wireless mobile communication network 15 may include one or more wired and/or wireless networks or connections. For example, network 15 may include a cellular network (e.g., a long-term evolution (LTE) network, a 5G network, or a code division multiple access (CDMA) network), a public land mobile network (PLMN), a local area network (LAN) (e.g., a Wi-Fi network), a wide area network (WAN), a metropolitan area network (MAN), a telephone network (e.g., the Public Switched Telephone Network (PSTN)), a private network, an ad hoc network, a wired connection, a wireless connection (e.g., a Bluetooth connection or a near field communication connection), or the like, and/or a combination of these or other types of networks or connections.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

The mobile devices 12-14 are capable of data communications through the network 15, and some devices may additionally be capable of voice telephone communications through the network 15.

The network 15 typically offers a variety of data services via the Internet 23, such as downloads, web browsing, email, etc. As illustrated, there is shown a laptop PC type user terminal 27 as well as a server 25 connected to the Internet 23; and the data services for the mobile devices 12-14 via the Internet 23 may be with such devices or any other type of device or system capable of data communications through the various interconnected networks. Data services for the mobile devices 12-14 can additionally be routed directly to the Internet 23 through other types of communication links, such as Wi-Fi links, in situations in which the mobile devices 12-14 are configured for communications across and have access to such links. The mobile devices 12-14 of users can receive or download software applications through the networks 23 and/or 15, such as application and/or other applications, and execute the applications written in various programming languages.

Mobile devices 12-14 can be portable handsets, smartphones, or personal digital assistants, although they may be implemented in other forms. For example, mobile devices 12-14 can be tablet computers, such as iPads, or other computing devices configured for communication through a mobile wireless communication network 15 and/or other types of wireless communication links. Program applications, including the present golf course activities management application, can be configured to execute on many different types of mobile devices 12-14. For example, a mobile device application can be written to execute on a Windows Mobile based mobile device, Android, iPhone, Java Mobile, or Blackberry based mobile device, for example.

The mobile communication network 15 can be implemented by a number of interconnected networks. Hence, the overall network 15 may include a number of radio access networks, as well as regional ground networks and a wide area network (WAN) interconnecting the regional ground networks to core network elements. Physical elements operated by one of the mobile service providers or carriers include a number of base stations represented in the example by the base stations 17. A base station 17 can include a base transceiver system, which can communicate via an antenna system at the site of the base station and over the air link with one or more of the mobile devices 12-14, when the mobile devices are within range. Each base station can be coupled to several antennas mounted on a radio tower within a coverage area.

The mobile devices 12-14 communicate over the air with a base station 17 and through the mobile wireless network 15 for various voice and data communications, e.g. services provided by an Internet-connected server 25 (e.g. a golf course activities management server) and/or application servers 31, 33, 34. The golf course activities management server may be defined by a single computer, server cluster and/or network appliance that is operated by a golf course management company or any other industry related organization that handles golf course management as would be appreciated by those skilled in the art.

Referring additionally to FIG. 2, an embodiment of a computing device 300, such as mobile devices 12-14 of FIG. 1, including a golfing management capability in accordance with features of the present invention will be described. FIG. 2 is a diagram of example components of a device 300. Device 300 may correspond to mobile device 12, 13 or 14. As shown in FIG. 2, device 300 may include a bus 310, a processor 320, a memory 330, a storage component 340, an input component 350, an output component 360, a communication interface 370, a display 380 and geolocation capabilities such as Global Positioning System (GPS) 390 connectivity and processing.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors capable of being programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include various computer memory types such as RAM, DRAM, SDRAM, DDR, GDDR, HBM, ROM, PROM, EPROM, EEPROM, NVRAM a hard disk (e.g., a magnetic disk, an optical disk, a magneto-optic disk, a solid state disk, etc.), a compact disc (CD), a digital versatile disc (DVD), a floppy disk, a cartridge, a magnetic tape, an SSD, and/or another type of non-transitory computer-readable medium, along with a corresponding drive.

Input component 350 may include a component that permits device 300 to receive information, such as via user input (e.g., components of a touch screen display, a keyboard, a keypad, a mouse, a button, a switch, a microphone, etc.). Additionally, or alternatively, input component 350 may include a sensor for sensing information (e.g., a geo-location module such as a global positioning system (GPS) component, an accelerometer, a gyroscope, an actuator, etc.). Output component 360 may include a component that provides output information from device 300 (e.g., a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Display 380 may be a digital display, for example, an LCD, LED, plasma display, touch screen or any other digital display capable of communicating information including displaying video.

GPS 390 is a satellite navigation device, colloquially called a GPS receiver, or simply a GPS, and is capable of receiving information from Global Navigation Satellite Systems (GNSS) satellites and then calculating the device’s geographical position. Using suitable software, the device 300 may display the position on a map, and it may offer routing directions. GPS 390 also provides geographical positioning information to the processor 320 for use in providing improved golf course management services.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 300 may include additional components, fewer components, different components, or differently arranged components than those shown in FIG. 2. Additionally, or alternatively, a set of components (e.g., one or more components) of device 300 may perform one or more functions described as being performed by another set of components of device 300.

Referring additionally to FIGS. 3 and 4, there are shown front views of a smartphone 400, which may be an example of the mobile devices 12-14 of FIG. 1, and computing device 300 of FIG. 2. The smartphone 400 has installed thereon (e.g. in the memory 330 or storage component 340), a golf course activities management application (e.g. also referred to as a golf course activities manager) that provides capabilities for a golfer (club member) to select and/or confirm golf course activity options for specific purposes on such a mobile device. The application includes instructions to be executed by the processor 320.

Execution of the instructions causes the processor 320 to: generate a graphical user interface (GUI) 410 on the display 380 that provides for the selection of various golf course activities options; control the mobile wireless communication interface 370 to connect to a golf course management server (e.g. server 25), via the wireless communication network 15, to interact, e.g. via GUI 410, therewith; and operate the display 380 to show Notices 420 (e.g. 24 hr. Confirmation Notice), Date/Time information 430, selectable options (such as Confirm Tee Time 440, and Cancel Tee Time 450) and various other notifications such as 10-minute Push 460, Fee warning 470, Cancellation warning 480, and course activity notice 490.

FIGS. 5-11 are additional front views illustrating a golfer’s mobile device or smartphone 400 displaying the GUI with various example screens regarding scheduling, food & beverage ordering, and summaries for the Golf Course Management System and Method according to an embodiment of the present invention. For example, FIG. 5 illustrates a GUI screen with information 501 to confirm 502 a golf course tee time wait list event or request. FIG. 6 illustrates a corresponding update 503 confirming a golfer’s wait list event or request and displayed to the golfer’s device 400. FIG. 7 illustrates another corresponding update 504 showing the golfers on the wait list or stand-by list. FIG. 8 illustrates a wait list confirmation request 505 being displayed to a golfer’s device 400 and requesting the golfer to confirm 506 or decline 507 the golf course tee time wait list modification to a confirmed tee time.

FIG. 9 illustrates some general notifications 508 provided from the golf course to the golfer via the golf course manager app. FIG. 10 illustrates an example food and beverage ordering screen 509 with options to bill the golfer’s account 510 or a credit card 511. FIG. 11 illustrates an example summary 512 of a golfer’s rounds, rating, benefits and rating tier system.

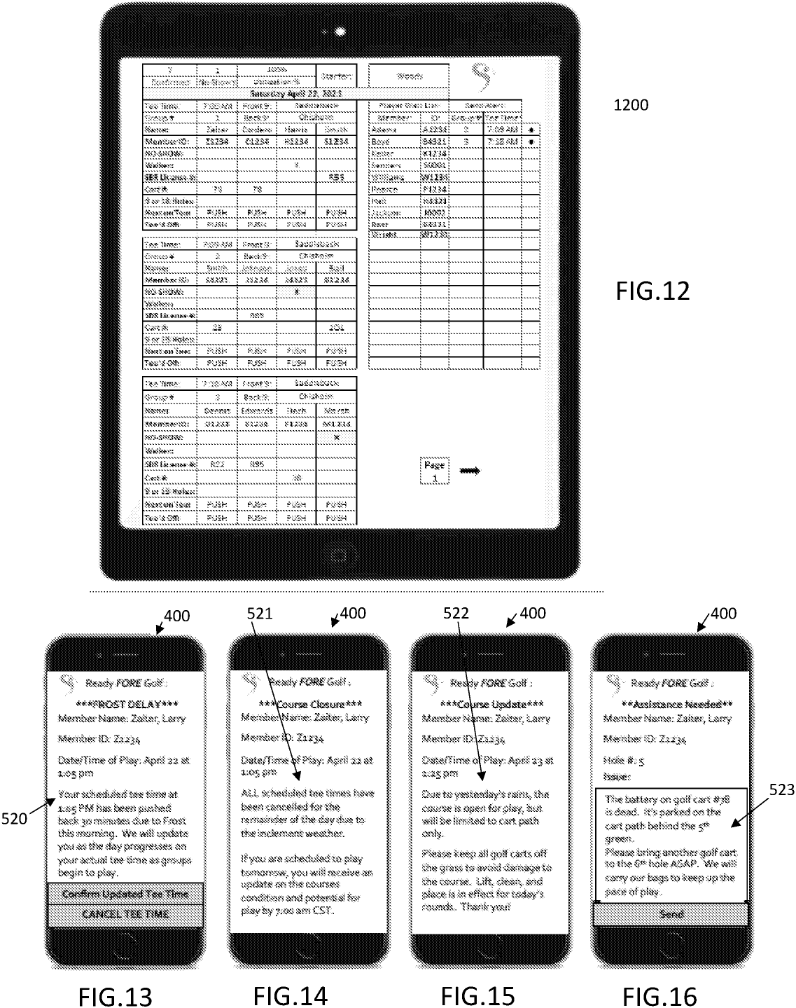

FIG. 12 is front view illustrating a Golf Course Starter’s computing device 1200 displaying a GUI with an example screen for the Golf Course Management System and Method according to an embodiment of the present invention. The computing device 1200 may be an example of the mobile devices 12-14 of FIG. 1, and computing device 300 of FIG. 2. The device 1200 has installed thereon (e.g. in the memory 330 or storage component 340), a starter’s activities management application (e.g. also referred to as a golf course starter manager) that provides capabilities for a starter (club official) to manage golf course activity options for specific purposes on such a device. The application includes instructions to be executed by the processor 320.

Club Members may be required to download the application (e.g. for Apple/Android). The application may not allow push notifications to be turned off, integrates with golf course booking or starter software and may update periodically (e.g., every ten minutes). Members may continue to book tee times online or through the pro shop. The application may initiate a push notification, for example, 24 hours in advance to confirm or cancel tee time. There is no need to check-in at the Pro-Shop. The starter’s tablet (e.g. FIG. 12) updates periodically (e.g., every 10 minutes). The starter may send a push notification to the next group when they are next to play. The wait list features can alert golfers upon cancellations for preferred tee times. A golfer ratings system may be implemented and advance access to preferred tee times based upon the rating.

The system and method may mitigate “no-shows” by charging a fee or pther penalty, for example, to the Members account if they “no-show” or cancel within a specified period. The wait list (e.g. a first-in-first-out wait list) may be provided for Members to fill preferred tee times if/when there are cancellations. Also, a Day-of-Play Member wait list may be included for the club starter to select in order as listed.

Additional features and benefits of the system, method and mobile app include the communication of course rules (e.g., FIG. 9) including, for example, automatically sent to each Member by the Starter when called to the first tee, Cart Path Only when the course is deemed too wet for carts, Ground under repair notices, Greens recently aeriated, Replace/sand fairway divots, Fix all ball marks on the green, Rake sand traps, Leave rakes inside the sand trap, Expected pace of play 4-hours, and Reward points for completing rounds in under 4-hours.

The system, method and mobile app can also be used to order food & beverage (e.g., FIG. 10) via the mobile app, from the snack shop, before making the turn, Promote daily specials e.g., Hot dog, Chips & Beer for $10. Options for charging to Member ID and/or to a credit card (e.g., for non-members) are also provided. The above-described features will improve pace of play, limit wait delays after 9-holes, and provide incremental revenue for the golf course or club.

Referring to FIG. 12, the system, method and software may provide a GUI for the mobile device of the golf course Starter who controls pace of play on the golf course by directing players to the first tee at appropriate times, etc. as is appreciated by those familiar with golf courses.

The Starter application and GUI syncs with pro shop booking system periodically (e.g. every 10 minutes) or allows starter to push sync, so there is no need for golfers to check-in at the Pro-Shop. Starter selects the appropriate 9-hole course to pull up the starters sheet, Starter sends a “Next on Tee” notification to the next group to play, Player wait list can alert golfers when a “no-show” occurs with the next available tee time via notification. Starter may enforce shared rental carts vs. single riders. Once the group tee’s off, starter time stamps the group and course rules are shared, Captures “no-show” Member and charges fee, and may track the following information (for example): Approved trail fee carts by license #; Rental carts by club cart #; Carts per group (shared or single); and Walkers. Starter may document members cart number used in case of abuse/damages.

Starter may push notifications to a group including, for example: Cart path only (when applicable); Expected pace of play; Pin location number; and Temporary greens (when applicable).

The Starter app may capture data in ad-hoc reportable formats. Data may be used by the system and method to develop a ratings system for Members, for example, as shown in FIG. 11. The system and method may track Member/Guest cancellations and frequency of play percentage, request a fee required to reserve for Guest (non-refundable within 48 hours of tee time), reward Members who do not cancel or “no-show” within 48 hours, reward points for maintaining average pace of play under 4-hours, reward those who book/play as scheduled with the right to book their tee times earlier than others (e.g. Diamond – 10 Day advance; Gold – 7 Day advance; Silver – 3 Day advance; Rating percentage TBD by Club).

Other features or benefits may include: No penalty for rounds cancelled due to weather related delays; Members can cancel prior to 24 hours without fee penalty, but will affect their Member rating; Bonus for Members entertaining Guests at the Club who, for example, play 18 & rent a cart, play 9 & rent a cart, rent clubs; Bonus for spending >$200/month in the Pro Shop (e.g. one free cart rental); Bonus for spending >$500/month on Food/Beverage (e.g. $25 Pro Shop Credit). Additionally, RFID and/or NFC capabilities (e.g. with the mobile device or a separate card) may be included to verify a member (e.g. at the first tee as well as when ordering snacks, drinks, and meals) to eliminate erroneous charges.

FIGS. 13-16 are front views illustrating a golfer’s mobile device 400 displaying a GUI with various example screens regarding weather/course information for the Golf Course Management System and Method according to an embodiment of the present invention. For example, inclement weather (heavy rains, thunder, lightning, tornado, snow, etc.) or weather delays may be communicated via push notification to Member’s playing with “weather delay” notification 520, “course closed” notification 521, “take cover” or estimated tee times due to the delay, for example. The system and method may alert golfers prior to each round with respect to: Recently aeriated and sanded greens; Cart path only notifications 522; Temporary green/ maintenance; Lift, clean and place on wet days, for example. The system and method may allow text communication with the Pro-Shop/Marshall during play for any on-course issues such as dead cart battery message 523, slow play, horse play, or emergency (player down, ambulance required) for example.

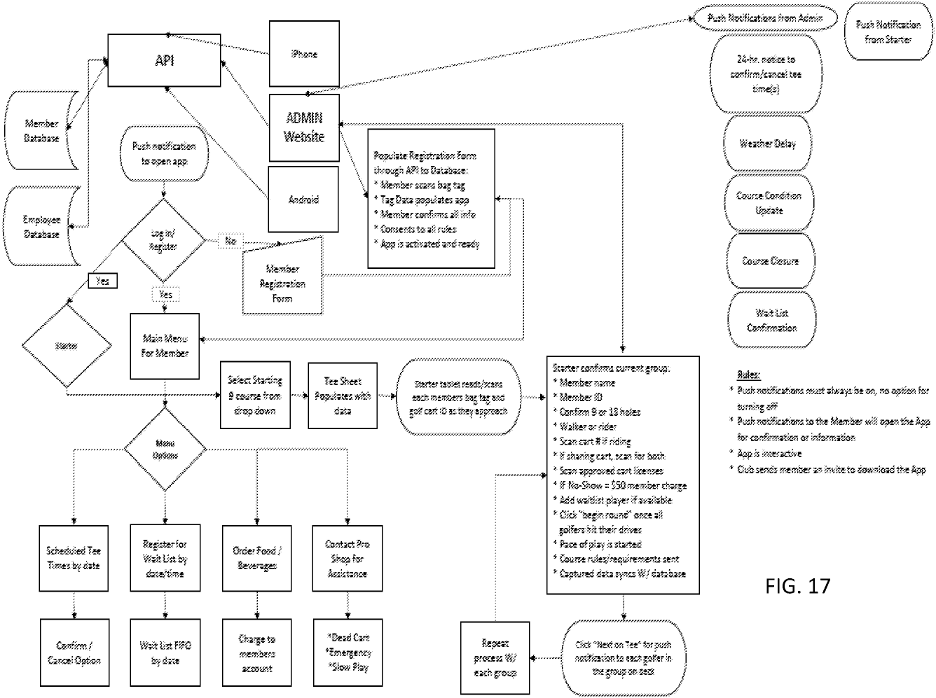

FIG. 17 is a flowchart illustrating the system and process architecture flowchart according to an embodiment of the present invention.

System mapping requirements may include: Required Member Information such as Member’s full name, Member in years, Club ID number, Home club name, Cell phone number, Email address, Trail fee license number (cart owners), Rental cart #, and Member rating category (once determined); and Suggested Point System based upon rounds scheduled vs. played percentage, Member “no-shows”, TBD’s turned to Member name within 24 hrs, TBD’s cancelled >48 hours & < 48 hours, Guest cancellations >48 hours & < 48 hours, Guest(s) scheduled and played, Monthly food/beverage spend (tiered), Rounds played under 4 hours, for example.

As such, data collection and processing may include: Scheduled Member tee time (date/time); How many TBD’s; Guest(s); Date reservation was made online; Full names of Member Guest(s); Non-refundable Guest deposit charged within 48 hours of tee time if not cancelled; Courses scheduled to play; Cancellations (TBD/Guest(s)/ Member) with Date/Time, Frequency, > 48 hours, > 48 < 24 hours, and < 24 hours, for example. Weights and/or percentages may be determined for each category of the Member rating system.

In various embodiments, operating the mobile application by a golfer may include inputting of a security verification, such as password verification and/or two-step authentication. Requesting input of the security verification may include requesting input of a biometric verification including the use of a fingerprint recognition, facial recognition, retinal recognition, iris recognition and/or voice recognition, as would be appreciated by those skilled in the art. A unique golfer ID may also be displayed.

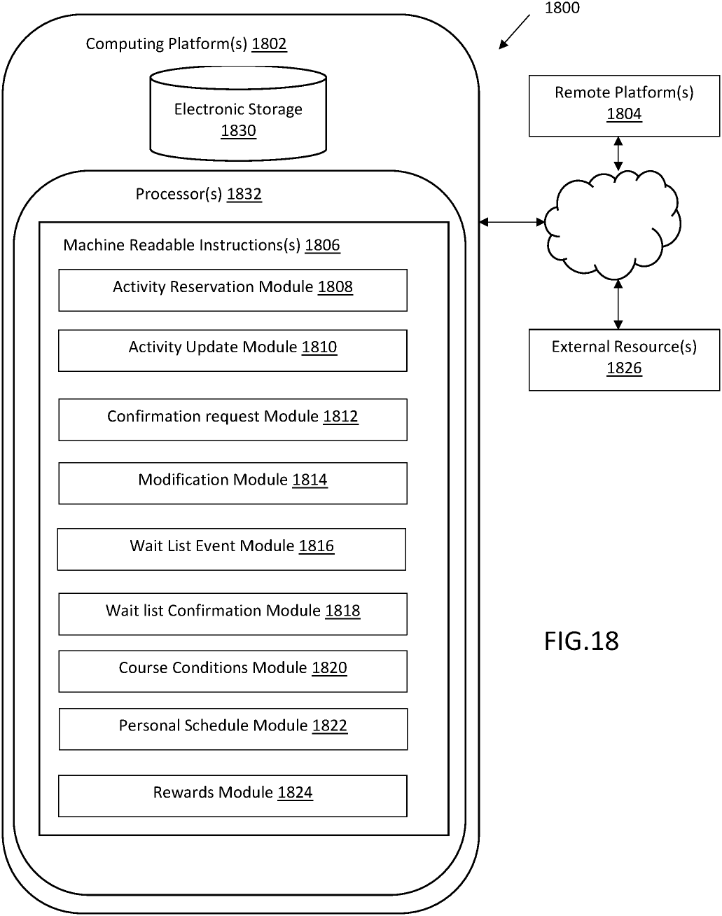

FIG. 18 is a block diagram of a computing system 1800 configured for providing the Golf Course Management System and Method, in accordance with the example embodiments. In some implementations, computing system 1800 can include one or more computing platforms 1802. Computing platform(s) 1802 can be configured to communicate with one or more remote platforms 1804 according to a client/server architecture, a peer-to-peer architecture, and/or other architectures. Remote platform(s) 1804 can be configured to communicate with other remote platforms via computing platform(s) 1802 and/or according to a client/server architecture, a peer-to-peer architecture, and/or other architectures. Users can access computing system 1800 via remote platform(s) 1804. According to some embodiments, one or more of computing platform(s) 1802, remote platform(s) 1804, and/or other components of computing system 1800 can be the same as or similar to one or more components of the computing system 10 of FIG. 1, the computing system 300 of FIG. 2, and/or other computing resources disclosed herein.

Computing platform(s) 1802 can be configured by machine-readable instructions 1806. Machine-readable instructions 1806 can include one or more instruction modules. The instruction modules can include computer program modules. The instruction modules can include one or more of Activity Reservation Module 1808, Activity Update Module 1810, Confirmation request Module 1812, Modification Module 1814, Wait List Event Module 1816, Wait list Confirmation Module 1818, Course Conditions Module 1820, Personal Schedule Module 1822, Rewards Module 1824, and/or other instruction modules.

Activity Reservation Module 1808 can be configured to determine a golf course tee time reservation event corresponding to a user accessing the golf course activities manager at the computing system 300 or 400. For example, as discussed above, a user may access the golf course activities manager and make a new reservation for a tee time (e.g., referred to as a golf course tee time reservation event). Activity Update Module 1810 can be configured to output, to the display a first update to the GUI, the first update based on the golf course tee time reservation event and a personal golf activities schedule corresponding to the user.

Confirmation request Module 1812 can be configured to output a first confirmation request 420 (e.g., a push notification) and an associated first set time period (e.g. 24 hours) to the golfer and determine a first result based thereon (e.g. golfer confirmed, golfer canceled, golfer did not reply). Modification Module 1814 can be configured to modify, based upon the first result, the golf course tee time reservation event to one of a confirmed golf course tee time reservation event (FIG. 4) and a cancelled golf course tee time reservation event. The first result may default to the cancelled golf course activity reservation event if the first set time period is exceeded without a user response to the first confirmation request.

Wait List Event Module 1816 can be configured to determine a golf course tee time wait list event corresponding to the user accessing the golf course activities manager at the computing system 300 or 400. For example, as discussed above, a user may access the golf course activities manager and make a new wait list reservation (FIG. 5) for a tee time (e.g., referred to as a golf course tee time wait list event). Activity Update Module 1810 can be configured to output, to the display a second update to the GUI, the second update based on the golf course tee time wait list event and a personal golf activities schedule corresponding to the user.

Wait list Confirmation Module 1818 can be configured to output a second conformation request 502 (e.g., a push notification) and an associated second time period (e.g. 5 minutes) to the golfer and determine a second result based thereon (e.g., golfer confirmed, golfer did not reply). The second result does not result in the confirmed golf course wait list event if the second set time period is exceeded without a user response to the second confirmation request.

Course Conditions Module 1820 can be configured to output golf course conditions updates based on the personal golf activities schedule corresponding to the user and one or more of weather updates, tee times delays, course modifications, and/or course closures, for example, as discussed with reference to FIGS. 9 and 13-15.

Personal Schedule Module 1822 can be configured to establish, e.g., within a computer readable memory 1830, the personal golf activities schedule corresponding to the user. The personal golf activities schedule may include a user identifier, golf course tee time reservation events, confirmed golf course tee time reservation events, cancelled golf course tee time reservation events, golf course tee time wait list events, and confirmed golf course tee time wait list events, associated with the user. The processor 1832 of the computing platform 1802 is configured to read the computer readable memory to determine the personal golf activities schedule and write to the computer readable memory 1830 to update or modify the personal golf activities schedule.

Rewards Module 1824 can be configured to establish, e.g., within the computer readable memory 1830, a rewards account corresponding to the user. The Rewards Module 1824 may determine, based upon user responses to confirmation requests, frequency of play, cancellations, no-shows, pace of play, club expenditures, etc., reward points to be awarded to, or removed from, the rewards account.

External resources 1826 can include sources of information outside of computing system 1800, external entities participating with computing system 1800, and/or other resources. In some implementations, some or all of the functionality attributed herein to external resources 1826 can be provided by resources included in computing system 1800.

Computing platform(s) 1802 can include electronic storage 1830, one or more processors 1832, and/or other components. Computing platform(s) 1802 can include communication lines, or ports to enable the exchange of information with a network and/or other computing platforms. Illustration of computing platform(s) 1802 in FIG. 18 is not intended to be limiting. Computing platform(s) 1802 can include a plurality of hardware, software, and/or firmware components operating together to provide the functionality attributed herein to computing platform(s) 1802. For example, computing platform(s) 1802 can be implemented by a cloud of computing platforms operating together as computing platform(s) 1802.

Electronic storage 1830 can comprise non-transitory storage media that electronically stores information. The electronic storage media of electronic storage 1830 can include one or both of system storage that is provided integrally (i.e., substantially non-removable) with computing platform(s) 1802 and/or removable storage that is removably connectable to computing platform(s) 1802 via, for example, a port (e.g., a USB port, a firewire port, etc.) or a drive (e.g., a disk drive, etc.). Electronic storage 1830 can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1830 can include one or more virtual storage resources (e.g., cloud storage, a virtual private network, and/or other virtual storage resources). Electronic storage 1830 can store software algorithms, information determined by processor(s) 1832, information received from computing platform(s) 1802, information received from remote platform(s) 1804, and/or other information that enables computing platform(s) 1002 to function as described herein.

Processor(s) 1832 can be configured to provide information processing capabilities in computing platform(s) 1802. As such, processor(s) 1832 can include one or more of a digital processor, an analog processor, a digital circuit designed to process information, an analog circuit designed to process information, a state machine, and/or other mechanisms for electronically processing information. Although processor(s) 1832 is shown in FIG. 18 as a single entity, this is for illustrative purposes only. In some implementations, processor(s) 1832 can include a plurality of processing units. These processing units can be physically located within the same device, or processor(s) 1832 can represent processing functionality of a plurality of devices operating in coordination. Processor(s) 132 can be configured to execute modules 1808-1824, and/or other modules. Processor(s) 1832 can be configured to execute modules by software; hardware; firmware; some combination of software, hardware, and/or firmware; and/or other mechanisms for configuring processing capabilities on processor(s) 1832. As used herein, the term “module” can refer to any component or set of components that perform the functionality attributed to the module. This can include one or more physical processors during execution of processor readable instructions, the processor readable instructions, circuitry, hardware, storage media, or any other components.

It should be appreciated that although modules 1808-1824 are illustrated in FIG. 18 as being implemented within a single processing unit, in implementations in which processor(s) 1832 includes multiple processing units, one or more of the modules can be implemented remotely from the other modules. The description of the functionality provided by the different modules described herein is for illustrative purposes, and is not intended to be limiting, as any of modules can provide more or less functionality than is described. For example, one or more of modules can be eliminated, and some or all of its functionality can be provided by other ones of modules. As another example, processor(s) 1832 can be configured to execute one or more additional modules that can perform some or all of the functionality attributed below to one of modules 1808-1824.

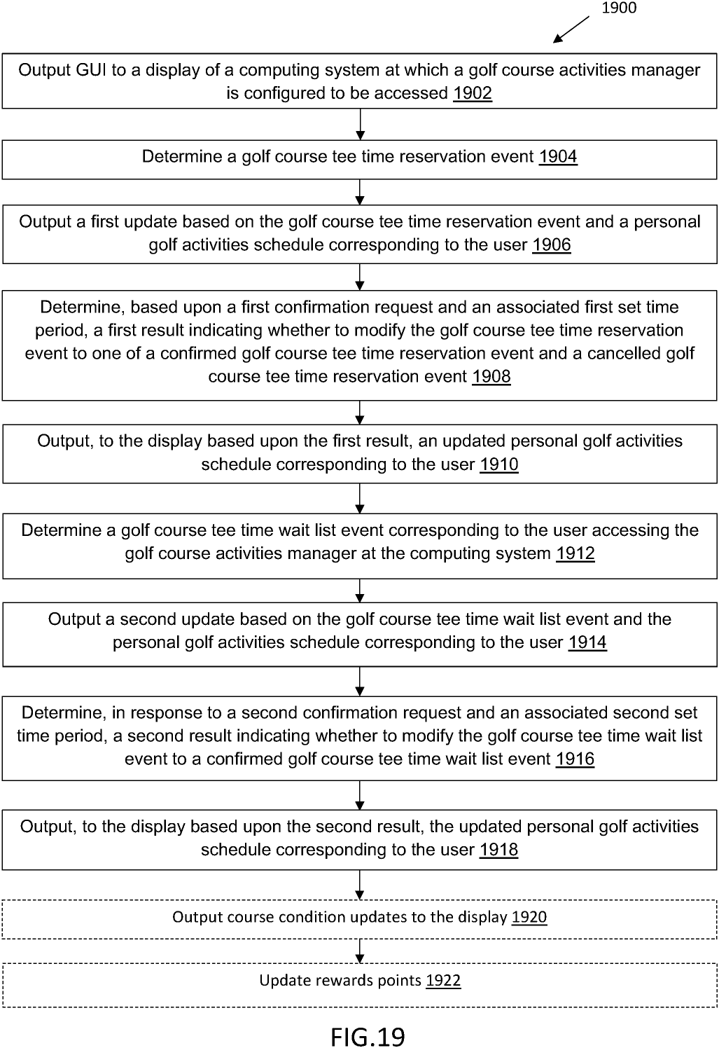

FIG. 19 is a flow chart showing functions of a method for providing the Golf Course Management System and Method, in accordance with the example embodiments. FIG. 19 is a flow chart showing a set 1900 of functions of that can be carried out using the computing system 10 of FIG. 1, the computing system 300 shown in FIG. 2, the computing system 1800 of FIG. 18, the computing platform(s) 1802, the remote platform(s) 1804, and/or other computing resources. A method of the example embodiments can include one or more functions of the set 1900 and/or a portion of one or more functions of the set 1900. Additionally, the order in which the functions of set 1900 are illustrated in FIG. 19 and described below is not intended to be limiting.

Accordingly, a method based on function(s) of the set 1900 can include a computer-implemented method involving a software application executed by the computing system (e.g., computing system 10 of FIG. 1), the computing system 1800 of FIG. 18, the computing platform(s) 1802, the remote platform(s) 1804, and/or other computing resources) with and/or in communication with a display screen. The software application involves graphically displaying a user interface that may include information, selectable features, updates etc..

FIG. 19 illustrates set 1900. Block 1902 includes outputting a graphical user interface (GUI) to a display of a computing system at which a golf course activities manager is configured to be accessed. The functions of block 1902 can be performed by one or more hardware processors configured by machine-readable instructions including a user interface outputting module, in accordance with the example embodiments.

Block 1904 includes determining a golf course tee time reservation event corresponding to a user accessing the golf course activities manager at the computing system. The functions of block 1904 can be performed by one or more hardware processors configured by machine-readable instructions including a module that is the same as or similar to Activity Reservation Module 1808, in accordance with the example embodiments.

Block 1906 includes outputting, to the display a first update to the GUI, the first update based on the golf course tee time reservation event and a personal golf activities schedule corresponding to the user. The functions of block 1906 can be performed by one or more hardware processors configured by machine-readable instructions including a module that is the same as or similar to Activity Update Module 1810 and/or the Personal Schedule module 1822, in accordance with the example embodiments.

Block 1908 includes determining, based upon a first confirmation request and an associated first set time period, a first result indicating whether to modify the golf course tee time reservation event to one of a confirmed golf course tee time reservation event and a cancelled golf course tee time reservation event. The functions of block 1908 can be performed by one or more hardware processors configured by machine-readable instructions including a module that is the same as or similar to Confirmation Request Module 1812, in accordance with the example embodiments.

Block 1910 includes outputting, to the display based upon the first result, an updated personal golf activities schedule corresponding to the user. The functions of block 1910 can be performed by one or more hardware processors configured by machine-readable instructions including a module that is the same as or similar to Modification Module 1814, in accordance with the example embodiments.

Block 1912 includes determining a golf course tee time wait list event corresponding to the user accessing the golf course activities manager at the computing system. The functions of block 1912 can be performed by one or more hardware processors configured by machine-readable instructions including a module that is the same as or similar to Wait List Event Module 1816, in accordance with the example embodiments.

Block 1914 includes outputting, to the display a second update to the GUI, the second update based on the golf course tee time wait list event and the personal golf activities schedule corresponding to the user. The functions of block 1914 can be performed by one or more hardware processors configured by machine-readable instructions including a module that is the same as or similar to Wait List Confirmation Module 1818, in accordance with the example embodiments.

Block 1916 includes determining, in response to a second confirmation request and an associated second set time period, a second result indicating whether to modify the golf course tee time wait list event to a confirmed golf course tee time wait list event. The functions of block 1916 can be performed by one or more hardware processors configured by machine-readable instructions including a module that is the same as or similar to Modification Module 1814, in accordance with the example embodiments.

Block 1918 includes outputting, to the display based upon the second result, the updated personal golf activities schedule corresponding to the user. The functions of block 1918 can be performed by one or more hardware processors configured by machine-readable instructions including a module that is the same as or similar to Activity Update Module 1810 and/or the Personal Schedule module 1822, in accordance with the example embodiments.

Block 1920 includes outputting, to the display golf course conditions updates to the GUI, the golf course conditions updates based on the personal golf activities schedule corresponding to the user and one or more of weather updates, tee times delays, course modifications, and/or course closures. The functions of block 1920 can be performed by one or more hardware processors configured by machine-readable instructions including a module that is the same as or similar to Course Conditions Module 1820, in accordance with the example embodiments.

Block 1922 includes establishing, within the computer readable memory, a rewards account corresponding to the user, and determining, based upon user responses to confirmation requests, frequency of play, cancellations, no-shows, pace of play, club expenditures, etc., reward points to be awarded to, or removed from, the rewards account. The functions of block 1922 can be performed by one or more hardware processors configured by machine-readable instructions including a module that is the same as or similar to Rewards Module 1824, in accordance with the example embodiments.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

Users may download an application on their mobile phones, tablets or any other mobile computing device, and even a vehicle.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A computer system to manage golf course activities, the system comprising:
one or more hardware processors and associated memory configured by machine-readable instructions to:
output a graphical user interface (GUI) to a display of a computing system at which a golf course activities manager is configured to be accessed;
determine a golf course tee time reservation event corresponding to a user accessing the golf course activities manager at the computing system;
output, to the display a first update to the GUI, the first update based on the golf course tee time reservation event and a personal golf activities schedule corresponding to the user;
determine, based upon a first confirmation request and an associated first set time period, a first result indicating whether to modify the golf course tee time reservation event to one of a confirmed golf course tee time reservation event and a cancelled golf course tee time reservation event;
output, to the display based upon the first result, an updated personal golf activities schedule corresponding to the user;
determine a golf course tee time wait list event corresponding to the user accessing the golf course activities manager at the computing system;
output, to the display a second update to the GUI, the second update based on the golf course tee time wait list event and the personal golf activities schedule corresponding to the user;
determine, in response to a second confirmation request and an associated second set time period, a second result indicating whether to modify the golf course tee time wait list event to a confirmed golf course tee time wait list event; and
output, to the display based upon the second result, the updated personal golf activities schedule corresponding to the user.

2. The computing system of claim 1, wherein the confirmed golf course tee time reservation event and the confirmed golf course tee time wait list event each comprise a date, time, and location of a tee time.

3. The computing system of claim 2, wherein the first confirmation request comprises a first push notification received at the computing system and requesting confirmation or cancellation of the tee time within the first set time period.

4. The computing system of claim 3, wherein the first result defaults to the cancelled golf course activity reservation event if the first set time period is exceeded without a user response to the first confirmation request.

5. The computing system of claim 2, wherein the second confirmation request comprises a second push notification received at the computing system and requesting confirmation or cancellation of the tee time within the second set time period.

6. The computing system of claim 5, wherein the second result does not result in the confirmed golf course wait list event if the second set time period is exceeded without a user response to the second confirmation request.

7. The computing system of claim 1, wherein the one or more hardware processors are further configured by machine-readable instructions to:
output, to the display, golf course conditions updates to the GUI, the golf course conditions updates based on the personal golf activities schedule corresponding to the user and one or more of weather updates, tee times delays, course modifications, and/or course closures.

8. The computing system of claim 1, wherein the one or more hardware processors are further configured by machine-readable instructions to:
establish, by the computing system within a computer readable memory, the personal golf activities schedule corresponding to the user;
wherein the personal golf activities schedule includes a user identifier, golf course tee time reservation events, confirmed golf course tee time reservation events, cancelled golf course tee time reservation events, golf course tee time wait list events, and confirmed golf course tee time wait list events, associated with the user; and
wherein a processor of the computing system is configured to read the computer readable memory to determine the personal golf activities schedule and write to the computer readable memory to change the personal golf activities schedule.

9. The computing system of claim 8, wherein the one or more hardware processors are further configured by machine-readable instructions to:
establish, by the computing system within the computer readable memory, a rewards account corresponding to the user;
determine, based upon at least user responses to confirmation requests, reward points to be awarded to, or removed from, the rewards account.

10. A method to manage golf course activities, the method comprising:
outputting a graphical user interface (GUI) to a display of a computing system at which a golf course activities manager is configured to be accessed;
determining a golf course tee time reservation event corresponding to a user accessing the golf course activities manager at the computing system;
outputting, to the display a first update to the GUI, the first update based on the golf course tee time reservation event and a personal golf activities schedule corresponding to the user;
determining, based upon a first confirmation request and an associated first set time period, a first result indicating whether to modify the golf course tee time reservation event to one of a confirmed golf course tee time reservation event and a cancelled golf course tee time reservation event;
outputting, to the display based upon the first result, an updated personal golf activities schedule corresponding to the user;
determining a golf course tee time wait list event corresponding to the user accessing the golf course activities manager at the computing system;
outputting, to the display a second update to the GUI, the second update based on the golf course tee time wait list event and the personal golf activities schedule corresponding to the user;
determining, in response to a second confirmation request and an associated second set time period, a second result indicating whether to modify the golf course tee time wait list event to a confirmed golf course tee time wait list event; and
outputting, to the display based upon the second result, the updated personal golf activities schedule corresponding to the user.

11. The method of claim 10, wherein the confirmed golf course tee time reservation event and the confirmed golf course tee time wait list event each comprise a date, time, and location of a tee time.

12. The method of claim 11, wherein the first confirmation request comprises a first push notification received at the computing system and requesting confirmation or cancellation of the tee time within the first set time period.

13. The method of claim 12, wherein the first result defaults to the cancelled golf course activity reservation event if the first set time period is exceeded without a user response to the first confirmation request.

14. The method of claim 11, wherein the second confirmation request comprises a second push notification received at the computing system and requesting confirmation or cancellation of the tee time within the second set time period.

15. The method of claim 14, wherein the second result does not result in the confirmed golf course wait list event if the second set time period is exceeded without a user response to the second confirmation request.

16. The method of claim 10, further comprising:
outputting, to the display golf course conditions updates to the GUI, the golf course conditions updates based on the personal golf activities schedule corresponding to the user and one or more of weather updates, tee times delays, course modifications, and/or course closures.

17. The method of claim 10, further comprising:
establishing, a computer readable memory, the personal golf activities schedule corresponding to the user;
wherein the personal golf activities schedule includes a user identifier, golf course tee time reservation events, confirmed golf course tee time reservation events, cancelled golf course tee time reservation events, golf course tee time wait list events, and confirmed golf course tee time wait list events, associated with the user; and
wherein a processor of a computing system is configured to read the computer readable memory to determine the personal golf activities schedule and write to the computer readable memory to change the personal golf activities schedule.

18. The method of claim 17, further comprising:
establishing, within the computer readable memory, a rewards account corresponding to the user; an
determining, based upon at least user responses to requests, reward points to be awarded to, or removed from, the rewards account.

19. A computer-readable memory having stored therein instructions executable by a processor to cause a computing system to perform functions comprising:
outputting a graphical user interface (GUI) to a display of a computing system at which a golf course activities manager is configured to be accessed;
determining a golf course tee time reservation event corresponding to a user accessing the golf course activities manager at the computing system;
outputting, to the display a first update to the GUI, the first update based on the golf course tee time reservation event and a personal golf activities schedule corresponding to the user;
determining, based upon a first confirmation request and an associated first set time period, a first result indicating whether to modify the golf course activity reservation event to one of a confirmed golf course tee time reservation event and a cancelled golf course tee time reservation event;
outputting, to the display based upon the first result, an updated personal golf activities schedule corresponding to the user;
determining a golf course tee time wait list event corresponding to the user accessing the golf course activities manager at the computing system;
outputting, to the display a second update to the GUI, the second update based on the golf course tee time wait list event and the personal golf activities schedule corresponding to the user;
determining, in response to a second confirmation request and an associated second set time period, a second result indicating whether to modify the golf course tee time wait list event to a confirmed golf course tee time wait list event; and
outputting, to the display based upon the second result, the updated personal golf activities schedule corresponding to the user.

20. The computer-readable memory of claim 19, wherein:
the first confirmation request comprises a first push notification received at the computing system and requesting confirmation or cancellation of the tee time within the first set time period;
the first result defaults to the cancelled golf course activity reservation event if the first set time period is exceeded without a user response to the first confirmation request;
the second confirmation request comprises a second push notification received at the computing system and requesting confirmation or cancellation of the tee time within the second set time period; and
the second result does not result in the confirmed golf course wait list event if the second set time period is exceeded without a user response to the second confirmation request.
